(19) United States
(12) Patent Application Publication
(10) Pub. No.: US 2026/0041983 A1
(43) Pub. Date: Feb. 12, 2026

(54) SYSTEM AND METHODS OF CONDUCTING DIGITAL INTERVIEWS AND REPORTS FOR SPORTING EVENTS

(71) Applicant: Neil Patrick Adams, Waterloo (CA)

(72) Inventor: Neil Patrick Adams, Waterloo (CA)

(73) Assignee: MAD PUCK INC., Waterloo (CA)

(21) Appl. No.: 19/286,327

(22) Filed: Jul. 31, 2025

Related U.S. Application Data
(60) Provisional application No. 63/681,194, filed on Aug. 9, 2024.

(51) Int. Cl. A63B 71/06; G06N 3/045; H04N 21/475

(52) U.S. Cl. CPC A63B 71/06; G06N 3/045; H04N 21/4756

(57) ABSTRACT

System and methods for generating and sending interview questions, gathering interview responses and generating and sending reports for sporting events. When a sports game has finished, post game interviews are generated for players, staff and fans using the game context. Interviews are distributed to the interviewees on their mobile devices where the interview is completed using text, audio or video methods. Post game reports are generated using the game context and the interview questions and responses previously generated and gathered. Post game reports are published and distributed to fans to enjoy. Machine learning models and AI may be used to generate the interview questions and reports.

### CROSS-REFERENCE TO RELATED APPLICATIONS

This application claims the benefit of U.S. Provisional Patent Application No. 63/681,194, filed Aug. 9, 2024, entitled System and Methods of Conducting Digital Interviews and Reports for Sporting Events, the content of which is incorporated herein by reference for all purposes.

### FIELD

The present application generally relates to systems and methods of generating and sending interview questions, gathering interview responses and generating and sending reports for sporting events, and in particular to systems and methods for digitally and automatically generating same.

### Introduction

During sports events (i.e., minor sports games), spectators (often parents) may record details such as game events and statistics during the game. Such events can keep others not present (i.e., parents or grandparents at home) updated with important game information (time, score, etc.). Such statistics may be used by coaches after the game to assist in practices and future games.

In professionally organized and well-funded sports leagues, it is common for players to be interviewed by reporters (before, during and after the game) to get their feelings and opinions on the game. Those interviews are often used in articles, magazines, TV shows, online streaming platforms or other such media to report on the game, player, team or league.

It is desired to bring a professional feel to minor sports by providing player interviews and game reports without the cost and effort that is often put into professional sports interviews and reports.

### BRIEF DESCRIPTION OF THE DRAWINGS

Reference will now be made, by way of example, to the accompanying drawings which show example embodiments of the present application, and in which:

FIG. 1 is a simplified schematic diagram showing an electronic device that tracks and displays game events and statistics, receives and conducts interviews and receives and displays reports, in accordance with an example embodiment of the present application;

FIG. 2 is a simplified block diagram illustrating an example system for tracking game events and statistics using multiple devices, generating and sending interview questions, gathering interview responses and generating and sending reports for sporting events in accordance with an example embodiment of the present application;

FIG. 3 is an illustration of the front view of an example electronic device displaying the data entry fields allowing the user to configure the post game report and post game interview settings, in accordance with an example embodiment of the present application;

FIG. 4 is an illustration of the front view of an example electronic device displaying fields of a post game interview for a text or audio based interview, in accordance with an example of the present application;

FIG. 5 is an illustration of the front view of an example electronic device displaying fields of a post game interview for a video based interview, in accordance with an example embodiment of the present application;

FIG. 6 is an illustration of the front view of an example electronic device displaying fields of a post game report, in accordance with an example embodiment of the present application;

FIG. 7 is an illustration of the front view of an example electronic device displaying fields for a set of post game interviews, in accordance with an example embodiment of the present application;

FIG. 8 illustrates, in a flowchart form, a method of generating and sending post game interviews, gather interview responses, and generating and sending post game reports, in accordance with an example embodiment of the present application;

Similar reference numerals may have been used in different figures to denote similar components.

### DESCRIPTION OF EXAMPLE EMBODIMENTS

In the present application, the term “and/or” is intended to cover all possible combinations and sub-combinations of the listed elements, including any one of the list elements alone, any sub-combinations, or all of the elements, and without necessarily excluding additional elements.

In the present application, the phrase “at least one of . . . or . . . ” is intended to cover any one or more of the listed elements, including any one of the listed elements alone, any sub-combinations, or all of the elements, without necessarily excluding any additional elements, and without necessarily requiring all of the elements.

In the present application, the phrase “the team” is normally intended to refer to a group of people associated with a single sports team. For example a team may include players, parents, grandparents, coaches, trainers, sponsors, managers, friends, supporters, etc. The team members are primarily concerned with the events that directly affect their team.

In the present application, the phrases “post game interview” and “post game report” generally refer to interviews and reports that occur after a game has finished and are used as examples only, and in particular should not limit the scope of the embodiments herein to interviews and reports that only occur after a game. It should be understood that interviews and reports may occur at any time, including before, during or after a game or event.

In the present application, the phrases “game interview” and “game report” are used as examples only and should not limit the scope of the embodiments herein to only games. Other types of interviews and reports are possible, including but not limited to practices, skills competitions, competitions in other sports (i.e., dance competitions, cheerleading competitions, figure skating competitions, other judged or timed events, etc.) tournaments, charity events, team events, league events, events, ad hoc interviews and reports, etc.

In the present application, many examples provided include players being the interviewees, but it should be understood that anyone could be an interviewee including for example players, staff, parents, friends, relatives, sponsors, officials, sport complex employees, AI generated fans or players, among other examples.

In the present application, the phrase “game context” refers to any information related to the game. Game context may include events from the game created using event input devices 210, client devices 220, server 230 and external devices 250. For example, game context may include goal information (times of goals, who scored, who assisted and who was on the ice), penalty information (times of penalties, type of penalty, duration of penalty), information about shots, faceoffs, hits, blocks, turnover, takeaways, giveaways or other events. The context may contain specific events, combined events or generated events. The game context may also contain event records 231, statistic records 233 and interview records 237a.

The game context may contain other game related information such as the game time, game location, team name, opponent name, score of the game, number and length of periods, the sport being played and any other information related to the game.

The game context may contain historical data such as previous results and statistics against an opponent or future schedule against an opponent.

The game context may include information about which players, staff or fans were at the game, which were absent and which were watching the game from another location.

The game context may contain cheers and comments from fans that occurred during an event. The game context may include information about game or team sponsors.

Different sports may have different terminology and different information provided in the game context. Many other game context data points are possible and understood to those of ordinary skill in the art. The terms “game context”, “event context”, “report context” may be used interchangeably and are meant to refer to the context needed to generate an interview or report.

The present application relates to generating and sending interview questions, gathering interview responses and generating and sending reports for sporting events. The sport can include any team or individual sport. The sport can be ice hockey, floor hockey, inline hockey, sledge hockey, ringette, baseball, soccer, football, rugby, lacrosse, box lacrosse, field lacrosse, among other examples.

The events (alternatively referred to as “game events”) can be any game related event that happens during the game associated with the players, coaches, referees, or spectators.

For instance in a hockey game, an event can be a faceoff, a shot, a goal, a penalty, a stoppage of play, time change, period change, song being played in the arena, a video clip of the game, among other examples. In another example, in a baseball game an event can be a pitch, foul ball, strike, stolen base, inning change, among other examples. A game event can also be an event that is specific to a player, for example, in an ice hockey game a game event can be a heart rate, motion information (in motion or stationary), on-ice status (on the ice or on the bench), location on the rink, time on the ice, among other examples.

Mobile devices may include smartphones, tablets, laptops, portable computers, wearable computing devices (e.g. smart watch, smart glasses, wearable activity monitor, or the like), augmented or virtual reality headset, scoreboard, communication system, or any other type of computing device that may have a communication module for communicating with another computing device.

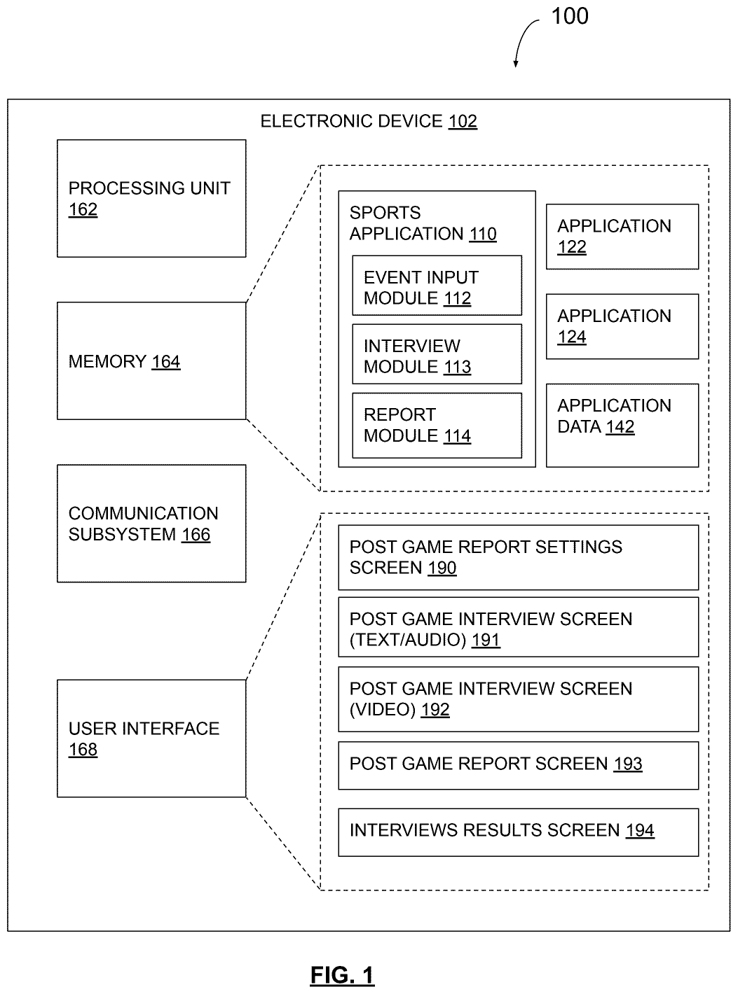

FIG. 1 is a schematic diagram 100 showing an electronic device 102 that tracks and displays game events and statistics, receives, displays and conducts interviews and receives and displays reports, according to an implementation. The electronic device 102 includes a processing unit 162, a communication subsystem 166, a user interface 168, and memory 164. An electronic device may include additional, different, or fewer features, as appropriate.

The example processing unit 162 can include one or more processing components (alternatively referred to as “processors” or “central processing units” (CPUs)) configured to execute instructions related to one or more of these processes, steps, or actions described above, in connection with one or more of the implementations disclosed herein. In some implementations, the processing unit 162 can be configured to generate control information, such as measurement report, or respond to received information, such as control information from a network node. The processing unit 162 can also include other auxiliary components, such as random access memory (RAM) and read-only memory (ROM).

The example communication subsystem 166 can be configured to provide wireless or wireline communications for data or control information provided by the processing unit 162. The communication subsystem 166 can include, for example, one or more antennas, a receiver, a transmitter, a local oscillator, a mixer, and a digital signal processing (DSP) unit. In some implementations, the communication subsystem 166 can support multiple input multiple output (MIMO) transmissions. In some implementations, the receivers in the communication subsystem 166 can be an advanced receiver or a baseline receiver. Two receivers can be implemented with identical, similar, or different receiver processing algorithms.

The example user interface 168 can include, for example, any of the following: one or more of a display or touch screen display (for example, a liquid crystal display (LCD), a light emitting diode (LED), an organic light emitting diode (OLED), or a micro-electromechanical system (MEMS) display), a keyboard or keypad, a trackball, a speaker, or a microphone. The user interface may also include externally hosted devices such as a smart watch, smart glasses, augmented reality device, virtual reality device or other such devices that can provide input or output.

As shown in FIG. 1, the example user interface 168 can output a post game report settings screen 190, a post game interview screen (text/audio) 191, a post game interview screen (video) 192, a post game report screen 193 or an interview results screen 194. The post game report settings screen 190 is a user interface object that allows the user to configure settings related to post game interviews and reports.

The post game interview screen (text/audio) 191 is a user interface object that displays interview questions and gathers interview responses using text or audio based input methods. The post game interview screen (video) 192 is a user interface object that displays interview questions and gathers interview responses using video based input methods. The post game report screen 193 is a user interface object that displays post game reports.

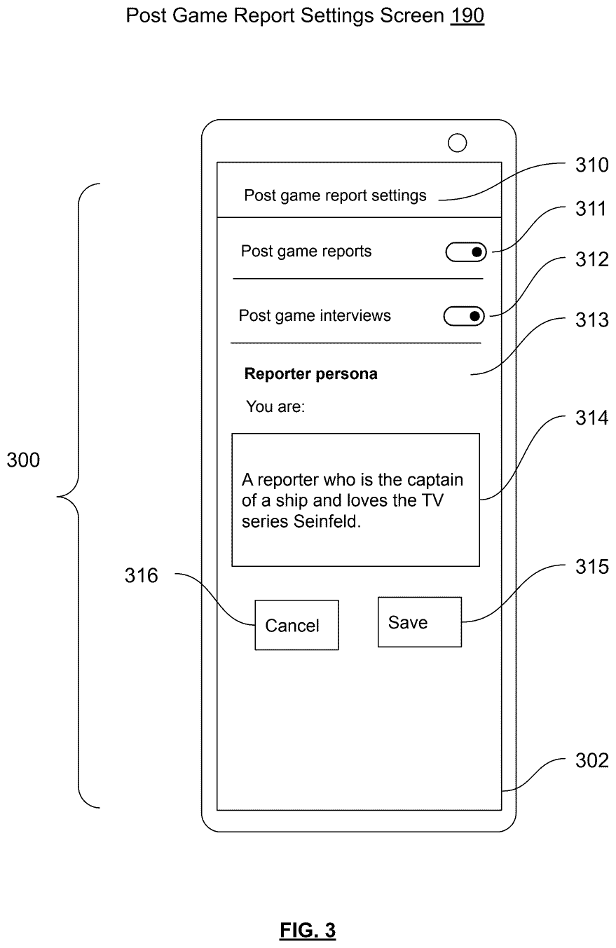

The interviews results screen 194 is a user interface object that displays post game interviews and responses. The interview responses can be received from a physical or virtual keyboard, a touch screen, a camera, a voice recognition processor, another user interface component, a server, a microphone, a sensor, or an external device. FIGS. 3-7 and associated descriptions provide additional details of these implementations. The user interface 168 can also include I/O interface, for example, a universal serial bus (USB) interface.

The example memory 164 can be computer-readable storage medium on the electronic device 102. Examples of the memory 164 include volatile and non-volatile memory, magnetic media, optical media, random access memory (RAM), read-only memory (ROM), removable media, and others. The memory 164 can store an operating system (OS) of the electronic device 102 and various other computer-executable software programs for performing one or more of the processes, steps, or actions described above. The memory 164 can store applications, data, operating system, and extensions for the electronic device 102. As illustrated, the memory 164 stores applications 122 and 124, data 142, and a sports application 110.

Applications, e.g., the applications 122, 124 and 110 can include programs, modules, scripts, processes, or other objects that can execute, change, delete, generate, or process application data. For example, applications can be implemented as Android, iOS, web or Enterprise Java Beans (EJBs). Design-time components may have the ability to generate run-time implementations into different platforms, such as J2EE (Java 2 Platform, Enterprise Edition), ABAP (Advanced Business Applications Programming) objects, ANDROID, iOS, or Microsofts's .NET. Further, while illustrated as internal to the electronic device 102, one or more processes associated with an application may be stored, referenced, or executed remotely. For example, a portion of an application may be an interface to a web service that is remotely executed. Moreover, an application may be a child or sub-module of another software module (not illustrated).

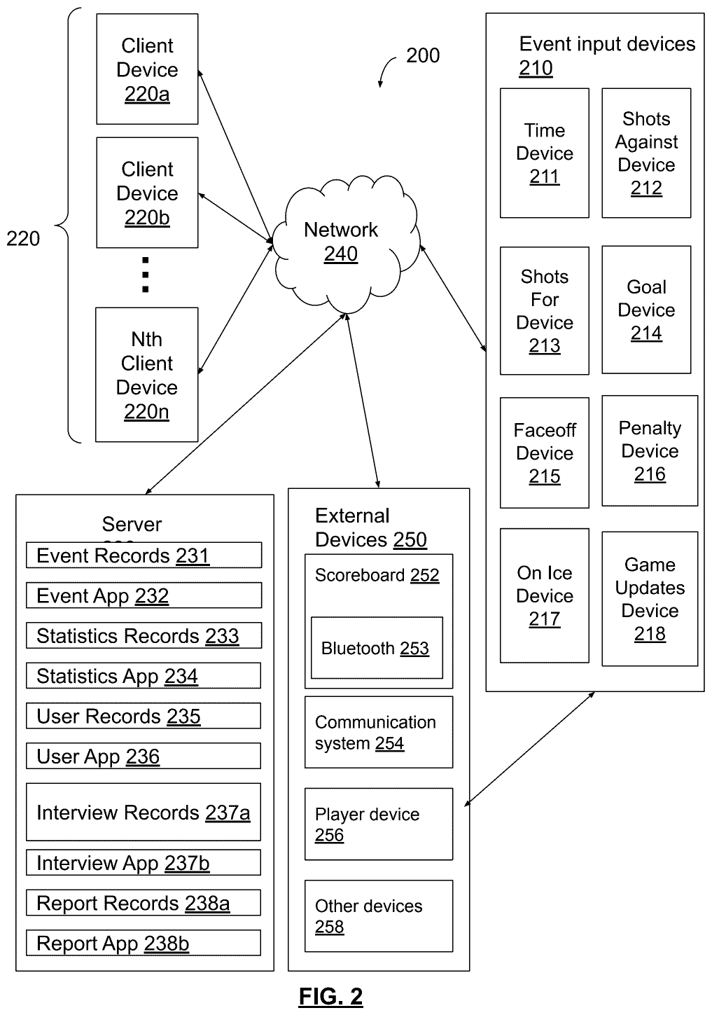

Application data 142 can include various types of data, e.g., files, classes, frameworks, backup data, business objects, jobs, web pages, web page templates, database tables, repositories storing business or dynamic information, and other information including parameters, variables, algorithms, instructions, rules, constraints, or references thereto. The application data 142 may include information that is associated with an application, a network, a user, and other information. For example, the data 142 may include data associated with applications 122, 124 and 110. In some cases, data associated with different applications can be stored in different portions of the memory 164. For example, data associated with the application 122 may be stored in trustzone. FIGS. 2-8 and associated descriptions provide additional details of these implementations.

The sports application 110 represents an application, set of applications, software, software modules, hardware, or any combinations thereof, that can be configured to receive and respond to post game interviews and receive and display post game reports.

The sports application 110 includes an event input module 112. The event input module 112 represents an application, set of applications, software, software modules, hardware, or any other combination thereof, that can be configured to receive event input parameters from the user, combine with input parameters from other devices and sensors, and generate game events and statistics.

The sports application 110 includes an interview module 113. The interview module 113 represents an application, set of applications, software, software modules, hardware, or any other combination thereof, that can be configured to receive or generate interview questions, display interview questions to the user using a variety of output methods, receive an interview response from the user using a variety of input methods and send interview responses. FIGS. 2-8 and associated descriptions provide additional details of these implementations and other example operations.

The sports application 110 includes a report module 114. The report module 114 represents an application, set of applications, software, software modules, hardware, or any other combination thereof, that can be configured to receive, generate or display reports. FIGS. 2-8 and associated descriptions provide additional details of these implementations and other example operations.

Turning to a general description, an electronic device, e.g., the electronic device 102, may include, without limitation, any of the following: computing device, mobile device, mobile electronic device, user device, endpoint Internet of Things (IoT) device, Enterprise of Things (EoT) device, mobile station, subscriber station, portable electronic device, mobile communications device, wireless modem, wireless terminal, television, desktop computer, scoreboard, sound system, communication system, printer, or other peripheral, vehicle, smart glasses, smart watch, virtual reality or augmented reality devices, or any other electronic device capable of sending and receiving data.

Examples of mobile devices may include, without limitation, a cellular phone, a personal data assistant (PDA), smart phone, laptop, tablet, personal computer (PC), pager, portable computer, portable gaming device, wearable electronic device, smart glasses, health/medial/fitness device, camera, scoreboard, sound system, communication system, or other mobile communications devices having components for communicating voice or data via a wireless communication network.

The wireless communication network may include a wireless link over at least one of a licensed spectrum and an unlicensed spectrum. The term “mobile device” can also refer to any hardware or software component that can terminate a communication session for a user. In addition, the terms “user equipment,” “UE,” “user equipment device,” “user agent,” “UA,” “user device,” and “mobile device” can be used synonymously herein.

While elements of FIG. 1 are shown as including various component parts, portions, or modules that implement the various features and functionality, nevertheless, these elements may instead include a number of sub-modules, third-party services, components, libraries, and such, as appropriate. Furthermore, the features and functionality of various components can be combined into fewer components, as appropriate.

FIG. 2 illustrates, in block diagram form, a system 200 for tracking sport game events using multiple devices, generating, sending and displaying interview questions, gathering interview responses and generating, sending and displaying reports, in accordance with an example of the present application.

The system 200 may include a plurality of event input devices 210 (illustrated individually as 211-218). In some examples, the system 200 may include a server 230, zero or more client devices 220 (illustrated individually as 220a-220n) and zero or more external devices 250 (illustrated individually as 252-258). The system 200 may include a network 240.

Each respective event input device 210 may be responsible for capturing one or more types of events. In some examples, the event input devices 210 may transmit the events to the server 230 for storage, further processing and to communicate out to client devices 220 and other event input devices 210.

The server 230 may be a single server, multiple servers, a server farm, or any other such arrangement of computing devices to implement a computing server-like functionality. The server 230 includes one or more processors, memory, and a communication module for providing communications capability with other computing devices, such as event input devices 210, client devices 220 or external devices 250. The server includes processor executable instructions stored in memory that, when executed, causes incoming game events and statistics to be stored, processed and distributed to other event input devices 210 and client devices 220. The server includes processor executable instructions stored in memory that, when executed, generates and saves interview questions, distributes interview questions to client devices 220 and event input devices 210, receives and stores interview responses from client devices 220 or event input devices 210, and generates, stores and distributes reports to client devices 220 or event input devices 210. In some examples the server 230 could be a Google Firebase server, an Amazon Web Service (AWS) server or Microsoft Azure server.

The server 230 may include zero or more event records 231. An event record may be a data structure for storing data relating to a game event. In some examples, the event record 231 may include a date/timestamp associated with the creation date of the record and a user identifier or user name associated with the user that created the record. In some examples, the event record 231 contains one or more player names or player identifiers associated with the players involved in the event. In some examples, the event record 231 contains a result such as a win or loss or an event type to distinguish that type of event. For example in an ice hockey game, a faceoff event could include information corresponding to the player name and identifier who took the faceoff, the location of the faceoff (offensive zone, defensive zone, neutral zone, etc.), and if the player won or lost the faceoff.

The server may include an event application 232 which listens for data changes to the event records 231 and sends notifications to users when important events occur, generates additional events, removes or combines duplicate events, or removes, updates or flags inappropriate comments added by team members.

The server 230 may include zero or more statistical records 233. A statistics record may be a data structure for storing statistics data for a player, group of players, game, a split or a team. In some examples, the statistics record 233 may include a player identifier, a team identifier, a game identifier, the type of statistic, a value, or other statistic related data.

The server 230 may include a statistics application 234 which listens for data changes to the statistical records 233 and resolves conflicts in the data (resulting from duplicate reports from multiple event input devices 210), generates new statistics, or updates existing statistics.

The server 230 may include zero or more user records 235. In some examples, the server 230 may store a user record 235 for each registered user in the system. The user record 235 may include the users name, email, phone number, notification tokens and role within the team. A role defines what the user can do within the system. In some examples, the roles include player, coach, statistician, parent, manager, sponsor, administrator or friend.

The server 230 may include a user application 236 for managing users access to data. For example a team member must only have access to teams which they belong to and a parent may only have access to their child's data.

The server 230 may include zero or more interview records 237a. An interview record may be a data structure for storing interview data for a player, staff member, or fan. In some examples, the interview record 237a may include a player identifier, a staff member identifier, a fan identifier, an interview question or questions, an interview response or responses, a machine learning prompt, the game context, a team identifier, a game identifier, an interview feature enabled flag, or other interview related data.

The server 230 may include an interview application 237b which waits for games to be finished or finalized, which determines if interviews are enabled, which selects which players, staff member or fans to interview, which generates machine learning prompts for interview questions, which generates interview questions, which sends notifications of players, staff or fans requesting interviews, which receives and stores interview responses, and which determines if interviews are complete.

The server 230 may include zero or more report records 238a. A report record may be a data structure for storing report data for a game, a practice, an event or for an ad hoc report. In some examples, the report record 238a may include a report or reports, an interview question or questions, an interview response or responses, a machine learning prompt, the game context, a team identifier, a game identifier, a report feature enabled flag, or other report related data.

The server 230 may include a report application 238b which waits for interviews to be finished or finalized, which determines if reports are enabled, which generates machine learning prompts for reports, which generates reports, which sends notifications of players, staff or fans with reports.

In another embodiment, one of the event input devices 210 being used in the game to track events or client devices 220, acts as a server agent, providing the functions of the server 230. For example, it is contemplated that a sports application 110 (FIG. 1) may be downloaded by the devices 210, 220 to act as the server, client or both.

The system 200 may include one or more event input devices 210 coupled to the network 240. An event input device 210 includes one or more processors, memory, and a communication module for providing communication capability with other computing devices. The event input device 210 may be a personal computer, a smartphone, a tablet, an augmented or virtual reality headset, a scoreboard, or any other computing device that may be configured to store data and software instructions and execute software instructions. FIG. 1 and associated descriptions provide additional details of these implementations.

An event input device 210 is a device that provides the ability to input game related events. For example in an ice hockey game, a game event may be a faceoff, goal, penalty, shot, etc. In order to simplify the process of entering game events, different devices/users can sign up to be responsible for entering a subset of the game events.

In the provided example embodiment, the total event input for a game is divided into 8 different game roles which are represented by the 8 event input devices 211-218. The event input devices 210 may be a time device 211, a shots against device 212, a shots for device 213, a goal device 214, a faceoff device 215, a penalty device 216, an on ice device 217, or a game updates device 218. Other embodiments may use a different distribution of the game events into the same number, fewer or more game roles (event input devices) or use different names for those roles or devices. Groupings for other sports would be different.

The number of users and event input devices 210 used to track game events may vary from game to game. For example in one game there may be a different user for each event input type (time, shots against, shots for, goals, faceoffs, penalties, on ice players, or game updates). In another example, one user may take on several roles (time, shots against, shots for) while the rest of the events are each handled independently by separate users. In another example one user may take on all roles alone. It may be understood that the system 200 may include any number of event input devices 210 each capturing one or more types of game events.

The system 200 may include one or more client devices 220 coupled to the network 240. A client device 220 includes one or more processors, memory, and a communication module for providing communication capability with other computing devices. A client device 220 may be a personal computer, a smartphone, a tablet, an augmented or virtual reality headset or any other computing device that may be configured to store data and software instructions and execute software instructions. FIG. 1 and associated descriptions provide additional details of these implementations.

A client device 220 can view a play-by-play of a game events that were generated by the event input devices 210 and external devices 250, may view statistics for a game, a split, a player, a team, may view or edit a list of users on the team, may view or edit a list of games associated with the team, may view or edit a list of teams associated with the user, may view or edit a list of players associated with the team, may view or edit a list of opponents, may view or edit a list of segments associated with the team, may generate or view interview questions, may receive interview responses from the user, may save interview responses locally, or may send interview responses to the server 230, or other devices 210, 220. The features described above may be limited based on the user's role on the team. The features above may be partially or fully implemented or supported by a server 230.

The system 200 includes a communication network 240 that enables a plurality of event input devices 210, a plurality of client devices 220, a server 230 and a plurality of external devices 250 to exchange data. The network 240 may be any type of network capable of enabling a plurality of communication devices to exchange data such as, for example, a local area network (LAN), such as a wireless local area network (WLAN) such as Wi-Fi™, a wireless personal area network (WPAN), such as Bluetooth™ based WPAN, a wide area network (WAN), a public-switched telephone network (PSTN), or a public-land mobile network (PLMN), which is also referred to as a wireless wide area network (WWAN) or a cellular network. The network 240 may comprise a plurality of the aforementioned network types coupled via appropriate methods known in the art.

While FIG. 2 illustrates client devices 220 and event input devices 210 as being separate components for illustration purposes, these components would typically be integrated into a single component and the role of the user within the team and/or game would determine if the device is acting as a client device 220, which is primarily a consumer of game data, or an event input device 210, which is primarily a producer of game data, or both a client device 220 and an event input device 210. The features and functionality of the event input devices 210 and client devices 220 can be combined into fewer components or separated into more components as appropriate.

The system 200 includes zero or more external devices 250, which are devices capable of capturing or receiving game related events or conducting and gathering interviews but may not conform exactly to that of an electronic device 102 as described in FIG. 1. For example an external device 250 might include a scoreboard 252, which refers to a physical scoreboard display and control module. In another example an external device includes a motion sensor, a heart rate sensor, a shock sensor, a sound system, a communication system, a player device, a camera, a Bluetooth™ sensor or any other device having the ability to capture or receive game events. In an embodiment an external device 250 is an event input device 210.

The system 200 may include zero or more traditional game scoreboards 252 physically located in the sports complex. The scoreboard 252 may include a handheld control, a master control, an indoor scoreboard display, an outdoor scoreboard display or a video display scoreboard, among others. In one embodiment the scoreboard 252 acts as an event input device 210 providing game events.

The scoreboard 252 may have a communication subsystem that allows communication with the server 230 over the network 240 to send or receive game events that can be stored as event records 231 or statistical records 233. The communication subsystem may use cellular, Wi-Fi™, Bluetooth™, Bluetooth™ Low Energy, NFC (near-field communication), or any other wired or wireless modes of communication.

The scoreboard 252 may communicate indirectly with the server 230 using an event input device 210 as a proxy for the events being generated by the scoreboard 252. For example the scoreboard 252 may communicate with an event input device 210 using a built-in or externally connected Bluetooth™ module 253. The scoreboard 252 may send a game event from the scoreboard 252 to the event input device 210 using Bluetooth™, which will then be sent to the server 230 via the network 240. The scoreboard may use cellular, Wi-Fi™, Bluetooth™, Bluetooth™ Low Energy, NFC (near-field communication), or any other wired or wireless modes of communication to communicate with the event input device 210.

The scoreboard 252 may be controlled or partially controlled from an event input device 210, a server 230, or server 230 using the event input device 210 as a proxy.

In the present application, the phrase “an external scoreboard acting as an event input device” is intended to refer to the above embodiments regarding how the scoreboard 252 communicates events to and from the system 200, the event input device 210, the client devices 220 and the server 230.

The system 200 may include zero or more traditional communication systems 254 located in the sports complex. The communication system 254 may include speakers, microphones, video recording devices, amplifiers, mixers, processors, CD players, portable music players, MP3 players, video displays, lights and lighting systems, smoke and smoke systems, fireworks, pyrotechnics, projection systems or other such devices.

The main role of a communication system 254 is to present media to attendees (players, staff, fans, officials, coaches, etc.) of a sports game. Media includes audio, video, lights, smoke, fireworks, pyrotechnics, projections, or any other methods used to communicate with or excite attendees.

The communication system 254 may have a communication subsystem that allows communication with the server 230 over the network 240 to send or receive game events that can be stored as event records 231 or statistical records 233. The communication subsystem may use cellular, Wi-Fi™, Bluetooth™, Bluetooth™ Low Energy, NFC (near-field communication), or any other wired or wireless modes of communication.

The communication system 254 may communicate indirectly with the server 230 using an event input device 210 as a proxy for the events being generated by the communication system 254. For example the communication system 254 may communicate with an event input device 210 using a built-in or externally connected Bluetooth™ module. The communication system 254 may send a game event from the communication system 254 to the event input device 210 using Bluetooth™, which will then be sent to the server 230 via the network 240. The communication system 254 may use cellular, Wi-Fi™, Bluetooth™, Bluetooth™ Low Energy, NFC (near-field communication), or any other wired or wireless modes of communication to communicate with the event input device 210. In another embodiment the event input device 210 may alter the game event before sending it to the server 230.

The communication system 254 may broadcast game events using a Bluetooth™ low energy beacon. Any event input device 210 or client device 220 may receive the game events and proxy the events to the server 230 via the network 240.

In one embodiment an event input devices 210 or server 230 communicate with the communication system 254 to play audio, video or any other output media supported by the communication system 254.

In another embodiment, media is generated by an event input device 210 or server 230 and sent to the communication system 254 to present. For example an audio or video clip of a live game interview or report is created by an event input device 210 or server 230 and sent to the communication system 254 to play.

In another embodiment the communication system 254 is used to conduct interviews using speakers, displays, microphones or video recording devices that are part of the communication system 254 in order to conduct interviews. The communication system may either generate the interview questions or receive the interview questions from the server 230 to present to interviewees. The communication system 254 may then send the interview responses (text, audio, video, etc.) to the server 230. In another embodiment the communication system presents the interview questions or responses to fans in the sports complex.

The system 200 may include zero or more player devices 256. A player device may be any device that can monitor the behaviour of a player while in a game. A player device may include a fitness tracker, smart watch, smart glasses, motion sensor, a heart rate sensor, blood pressure sensor, a shock sensor, an ultrasonic sensor, a camera, a vibration sensor, GPS, microphone, video camera or any other device having the ability to capture or receive game events from a player. Examples of player devices 256 include, but are not limited to Fitbit, Apple Watch, Google Watch among others.

In one embodiment the player device 256 has a communication subsystem that allows communication with the server 230 over the network 240 to send or receive game events that can be stored as event records 231, as statistical records 233, as interview records 237a or as report records 238a. The communication subsystem may use cellular, Wi-Fi™, Bluetooth™, Bluetooth™ Low Energy, NFC (near-field communication), or any other wired or wireless modes of communication.

Each player device 256 may detect game events that are specific to that player. For example, in an ice hockey game a player device 256 might detect and report game events including if a player is in motion, the heart rate of the player, the speed the player is moving, the maximum speed of the player in the game, the average speed of the player in the game, the distance travelled in the game, how long a player was on the ice and the location of the player on the ice, among others.

Player devices 256 may communicate indirectly with the server 230 using an event input device 210 or client device 220 as a proxy for the events being generated by the player device 256. For example the player device 256 may communicate with an event input device 210 using a built-in or externally connected Bluetooth™ module. The player device 256 may use cellular, Wi-Fi™, Bluetooth™, Bluetooth™ Low Energy, NFC (near-field communication), or any other wired or wireless modes of communication to communicate with the event input device 210 or client device 220. For example, the player device 256 may send a game event to the event input device 210 using Bluetooth™, which will then be sent to the server 230 via the network 240. In another embodiment the event input device 210 may alter the game event before sending it to the server 230.

In another embodiment the player device 256 may have a microphone or video camera for recording audio or video which may be used as content for a post game interview or post game report. In one embodiment the player must first authorize any audio or video clip before it is made available to the system 200 for use in an interview or report.

FIG. 3 illustrates an example user interface displaying the data entry fields allowing the user to configure the post game report and post game interview settings, in accordance with an example embodiment of the present application. In the illustrated example, a sports application 110 is executing on the electronic device 102.

As illustrated, an example user interface 300 of the sports application 110 is displayed on a screen 302 of the electronic device 102.

The example user interface 300 includes fields 310-316 that are outputted by the sports application 110.

In the illustrated example, the field 310 is used to display the title of the screen.

In the illustrated example, the field 311 is used to toggle the post game reports on or off. In the current example post game reports are enabled. When the post game reports toggle 311 is in the off position, no post game reports are generated when a game is finished and other input fields (312-314) may be disabled or hidden from the user if they depend on the post game reports feature to be enabled. In some embodiments post game interviews are independent from post game reports and so fields 311-14 should not be hidden. In another embodiment, where post game interviews are independent from post game reports, post game reports toggle 311 may not exist or may exist on another settings screen.

In the illustrated example, the field 312 is used to toggle the post game interviews on or off. In the current example post game interviews are enabled. When the post game interviews toggle 312 is in the off position, no post game interviews are conducted and other fields on the screen may be hidden or disabled if they depend on the post game interviews feature to be enabled.

In the illustrated example, the field 313 is a section header for the reporter persona section of the settings screen 300, containing settings related to the persona to be used for the reporter conducting the interviews and writing the post game report. In another embodiment multiple personas are allowed to be configured, for example one for the interviewer and one for the reporter (the person who writes the reports). In another embodiment no personas are specified and are automatically pre-configured by the system; for example to always use the same persona, to alternate between pre-configured personas or using other methods known to those skilled in the art. In another embodiment, personas are not needed if the interviews or reports are generated algorithmically as they are not using a machine learning model to generate.

In the illustrated example, the field 314 is an input field allowing the user to specify the persona of the reporter of the post game interviews and the post game reports. The persona would typically be used to provide the machine learning model with additional context in order to generate the results. In this example the user is requesting that the results are generated by a ship's captain who loves Seinfeld, and therefore the resulting interviews and reports may contain words like “Ahoy Mateys” and “Serenity Now”. For example and interview question may be, “Ahoy there, Matey! How did you feel going into the second period?”.

In the illustrated example, the field 315 allows the user to save the changes made to the post game report settings screen and field 316 allows the user to cancel and discard any changes made. Other buttons or actions are possible to allow the user to save or discard changes.

In another embodiment other settings are possible; for example allowing the user to select the number of players to interview, the time to wait for the game to be finalized, the time to wait for interviews to complete, an independent persona for the interviewer vs the reporter, multiple persona's which can be used or settings to restrict certain words from the interview or report responses. In another embodiment a staff member can set a different persona per player or fan. In another embodiment each player or fan can set their own persona. Other settings are possible.

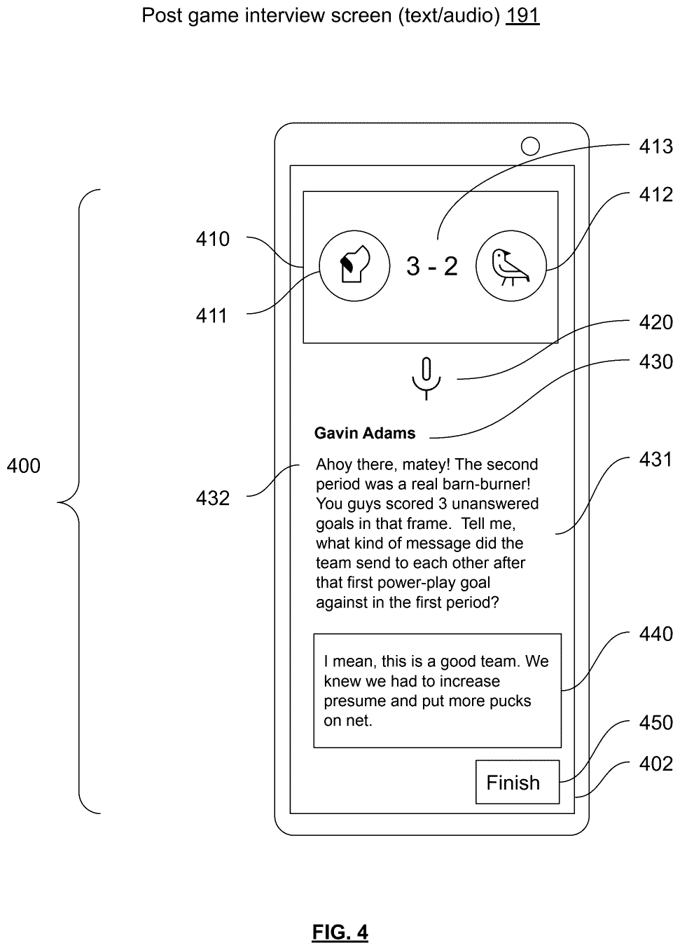

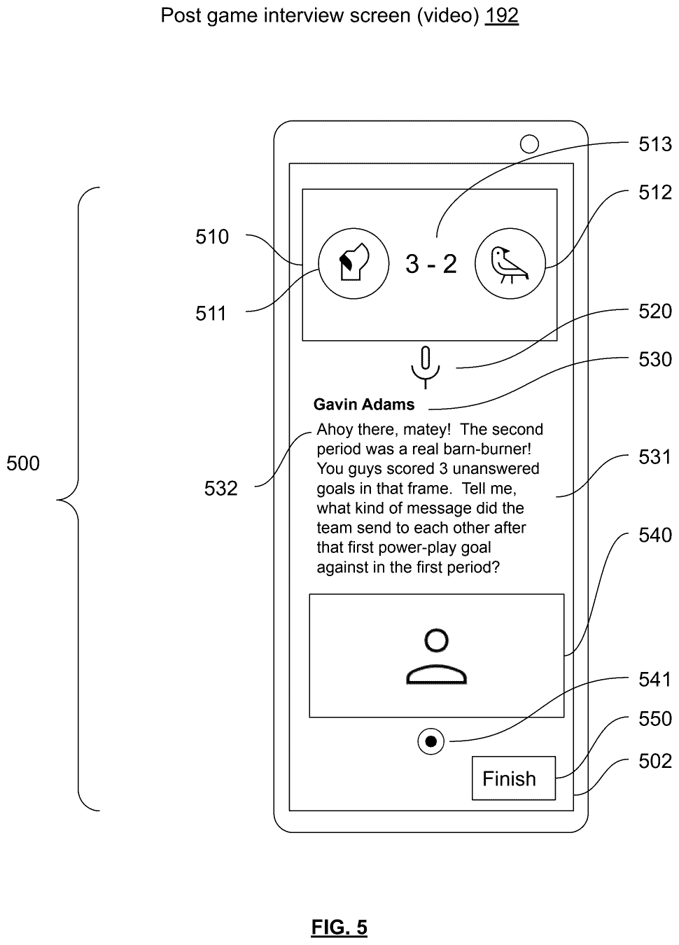

Referring now to both FIG. 4 and FIG. 5 which show similar user interfaces for an example post game interview using different input methods.

FIG. 4 illustrates an example user interface displaying fields of a post game interview for a text or audio based interview, in accordance with an example of the present application. In the illustrated example, a sports application 110 is executing on the electronic device 102.

FIG. 5 illustrates an example user interface displaying fields of a post game interview for a video based interview, in accordance with an example embodiment of the present application. In the illustrated example, a sports application 110 is executing on the electronic device 102.

As illustrated, an example user interface 400, 500 of the sports application 110 is displayed on a screen 402, 502 of the electronic device 102.

The example user interface 400 includes fields 410-450 that are outputted by the sports application 110. The example user interface 500 includes fields 510-550 that are outputted by the sports application 110.

In the illustrated examples, fields 410, 510 show a header which illustrates the final state of the game, providing some context to the preceding interview by displaying game parameters 411-413, 511-513 and well as adding some visual enhancements to the screen. In this example, the home team's logo is shown in field 411, 511, the opponents logo is shown in field 412, 512 and the score (home-opponent; 3-2) is shown in field 413, 513. The header is optional and different implementations or sports may show different visualizations and game parameters, for example in another embodiment the header section 410, 510 may show the number of shots for-against in the game.

In the example shown, the header sections 410, 510 show the game context for the final state of the game as the preceding interview is a post game interview. In another embodiment the interview being conducted is a live game interview (for example between 2nd and 3rd periods of an ice hockey game) and therefore the header sections 410, 510 show the game context for the current state of the game at the time of the interview. In another embodiment the interview being conducted is a pre-game interview (for a game which has not yet started) so the header section 410, 510 may show information about the upcoming game, for example who the opponent is, past results against the opponent or possible predictions about the upcoming game. Many configurations and locations of the header 410, 510 are possible and well known to those in the art.

In the illustrated example, field 420, 520 show a microphone icon which is designed to simulate a live interview environment, providing a realistic and engaging user experience for players responding to interview questions. The microphone icon is utilized to create a visual representation of a traditional interview setup, thereby enhancing the realism and immersive quality of the interview experience. This visual cue signals to the user that the interaction mimics a live interview scenario, fostering a more engaging and authentic atmosphere.

In another embodiment the microphone icon 420, 520 may also be a button, which when clicked records the user's voice. In another embodiment the microphone icon 420, 520 first reads the interview question or questions to the player using a speaker on the device 102, before receiving their response. In another embodiment the recorded voice answer received from the user is stored and available to fans in addition to the text response. Many combinations of text and audio responses are possible and known to those in the art.

In another embodiment, the recorded voice is converted to text in order to populate the interview answer field 440 in FIG. 4.

In the illustrated example, field 430, 530 shows the name of the interviewee. In this example a player (first, last) is being interviewed. In another embodiment, field 430, 530 also shows a player's number or player's picture; other representations of the player are possible. In the example a player is shown but in other embodiments the interview may be conducted by a staff member (coach, assistant coach, trainer, etc.) or a fan (parent, grandparent, friend or family); many visual representations of the staff member or fan are possible and understood to those in the art.

In the illustrated example, field 431, 531 shows the interview question being asked to the player (Gavin Adams). In another embodiment multiple questions are asked. In another embodiment the interview questions are played to the player using audio methods using a text to speech algorithm or model. In another embodiment the interview questions are played using audio from a recording from another player, staff member, fan or AI generated.

In the illustrated example, field 432, 532, shows a segment of the interview question, “Ahoy there, matey!” which illustrates the use of the users supplied reporter persona entered in field 314 of the post game report settings screen 190 of FIG. 3 and was generated by a machine learning model or AI.

In FIG. 4, in the illustrated example, field 440 shows an editable text entry field which allows the player to enter a response to the interview questions. In another embodiment a parent enters the interview response for the child using either the child's device or the parents device. In another embodiment, the player's voice is recorded and converted to text automatically as the player speaks and the text is entered into field 440 for the user; the original audio recording may also be saved and available as part of the interview response.

In FIG. 5, in the illustrated example, field 540 shows a video field showing the video content from a camera (front, back or external to the device) of the electronic device 102, representing a video content for a video interview with the interviewee. Field 541 shows a record button, which when pressed starts recording the video content of the interviewee shown in field 540. After recording has started, the image on the button of field 541 may change to a stop or pause button or other similar buttons may also exist on the screen 502 to provide such functionality. Many possible video recording options are possible to those skilled in the art.

In another embodiment the background of the video may be changed or edited. For example the backdrop may be replaced by a banner showing the teams logo. In another embodiment, additional filters may be applied to the video either automatically or using manual request features and buttons available in the user interface.

In another embodiment the interview questions 431, 531 may be outputted using voice or video in addition to or instead of the text interview questions. The text, audio or video content for the interview question may be manually generated from a staff member, fan or player, maybe pre-created, maybe machine generated using a machine learning model or AI or by other means known to those in the art.

In the illustrated example, field 450, 550 shows a finished button, which when clicked submits the interview response for the interviewee. In another embodiment, after pressing the button 450, 550 the interview response is checked for length, spelling, grammar, vulgar language or other such criteria to confirm its validity, and if invalid the interviewee is prompted to address the issues. When a valid interview response 440, 540 is provided, the interview response 440, 540 is saved on the event input device 210, the client device 220, sent and saved on the server 230 or a combination thereof.

In another embodiment the time remaining for the interview (before the report is generated) is also displayed (not shown in FIGS. 4, 5).

In another embodiment, the post-game interview interface supports an interactive AI-based interview experience, where the user engages in a dynamic, back-and-forth conversation with an AI interviewer. Rather than presenting a static list of questions, the sports application 110 utilizes an embedded conversational engine that adapts the interview flow in real-time based on the user's responses and the game context. The interview begins with an initial question generated by the AI, tailored to the specific game outcome, player performance, or predefined persona settings. After the user responds-via text, audio, or video-the AI interviewer processes the answer and formulates relevant follow-up questions, simulating a natural and engaging dialogue.

This AI-driven approach enhances realism by mimicking the cadence of live, unscripted interviews typically conducted by sports reporters. The questions may be generated using a large language model (LLM) fine-tuned with domain-specific sports data and personalized based on the selected persona (e.g., enthusiastic fan, stern coach, humorous reporter). For example, if a player mentions a key goal in their initial answer, the AI may respond with, “Walk us through that goal—what were you thinking as you approached the net?”

The interactive interview may span multiple question-response turns, and each exchange is displayed chronologically in a conversational layout, similar to a messaging app or chatbot interface. The responses may be recorded in text, audio, or video formats, and the entire interview thread is saved as a unified report. In one embodiment, this feature is available only in certain tiers of the sports application 110 (e.g., premium teams), while in another embodiment, follow-up depth or number of exchanges is configurable by a coach or team administrator. The AI interviewer may also adapt its tone and complexity based on the age or experience level of the player being interviewed.

In an embodiment where a post-game report is generated, the results of the interactive AI interview may be automatically integrated into the report as a narrative or Q&A section. The AI system may select key exchanges from the conversation to summarize or embed directly into the report, preserving the tone and persona used during the interview. For example, a particularly insightful response from a player might be highlighted under a “Post-Game Reflections” section, or the full AI-led interview may be appended to the end of the report. In another embodiment, the interactive interview is treated as a standalone media object—distributed separately from the formal post-game report and optionally shared with fans, coaches, or team members through the sports application 110. Administrators or staff may configure whether and how the interview content is used in reports, allowing for flexible workflows where the interview supplements, replaces, or remains independent of traditional written summaries. This integration supports both automated and manual editorial controls, enabling teams to maintain oversight of published content while benefiting from the rich context generated through AI-guided dialogue.

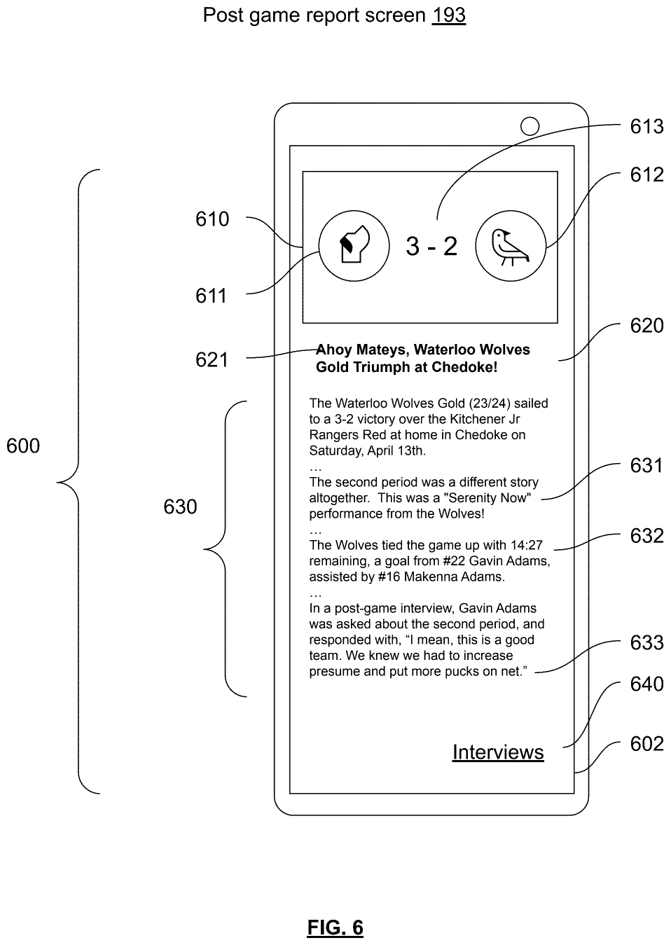

FIG. 6 illustrates an example user interface displaying fields of a post game report, in accordance with an example embodiment of the present application. In the illustrated example, a sports application 110 is executing on the electronic device 102.

As illustrated, an example user interface 600 of the sports application 110 is displayed on a screen 602 of the electronic device 102.

The example user interface 600 includes fields 610-640 that are outputted by the sports application 110.

In the illustrated example, field 610 shows the game context for the final state of the game as the preceding report is a post game report. In another embodiment the report is a live game report (for example between 2nd and 3rd periods of an ice hockey game) and therefore the header section 610 shows the game context for the current state of the game at the time of the report. In another embodiment the report is a pre-game report (for a game which has not yet started) so the header section 610 may show information about the upcoming game, for example who the opponent is, past results against the opponent or possible predictions about the upcoming game. Many configurations and locations of the header 610 are possible and well known to those in the art.

In the illustrated example, the field 620 shows a title for the post game report. The title may have been generated using algorithmic, machine learning model or AI methods. In another embodiment a different persona is used for the title generation than is used for the interview questions or reports. In another embodiment the context of the game is used as input into the title generation. In another embodiment a title is selected from a set of pre-configured titles with templates (for example a set for wins, close wins, big wins, losses, close closes, big losses, ties, etc.), many possible templates and preconfigured titles are obvious to those in the art. In another embodiment the title is written by a staff member, a player, a fan or combination thereof.

In the illustrated example, field 621, shows a segment of the report title, “Ahoy Mateys,” which illustrates the use of the users supplied reporter persona entered in field 314 of the post game report settings screen 190 of FIG. 3 and was generated by a machine learning model or AI.

In the illustrated example, field 630 shows the post game report. The report may have been generated using algorithmic, machine learning model or AI methods. In another embodiment the context of the game is used as input into the report generation. In another embodiment a report is selected from a set of pre-configured reports with templates (for example a set for wins, close wins, big wins, losses, close closes, big losses, ties, etc.), many possible templates and preconfigured reports are obvious to those in the art. In another embodiment the report is written by a staff member, a player, a fan or combination thereof.

In the illustrated example, field 631 shows a segment of the report, “Serenity Now” which illustrates the use of the users supplied reporter persona entered in field 314 of the post game report settings screen 190 of FIG. 3 and was generated by a machine learning model or AI.

In the illustrated example, field 632 shows information about that game that was generated by machine learning mode or AI methods using the game context.

The report field 630 may include zero or more interviews and interview responses 633. An interview may include the interview questions, the interview answers or a combination thereof. The interviews may be included inline within the flow of the report, separately within the report, in a different section of the report or accessible from another screen. An interview question may contain the full interview question, part of the interview question, an edited interview question, an expanded upon interview question, an exaggerated interview question or a combination thereof. An interview answer may contain the full interview response, part of the interview response, an edited interview response, an expanded upon interview response, an exaggerated interview response, a completely fabricated interview response, a previous interview response from the same or different persons or a combination thereof. An interview answer may optionally also include an AI-generated response in cases where the interviewee does not respond, provides an incomplete answer, or responds with content deemed inappropriate. In such cases, the AI may generate a suitable substitute response based on the interview question, game context, and configured persona settings.

The report field 630 may include zero or more player, staff or fan insights which are added before, during or after a game. For example in a pickup hockey game, typically there are not a lot of game events (goals, penalties, etc.) entered for a game; so instead, one of the players may add insights (or key moments) into a client device 220, an event input device 210, or an external device 250. For example an insight might be “Player X got a hat trick”. An insight used in the report may contain part of the original insight, may be edited, maybe expanded upon, maybe exaggerated or a combination thereof. In another embodiment the user is asked to enter insights when they end the game on a client device 220, an event input device 210, or an external device 250

The illustrated example shown in FIG. 6 shows a post game report, that is, a report generated after the game has finished showing information about the finished game, including zero or more interviews. In another embodiment the report is a pre game report showing predictions or information about an upcoming game and including zero or more interviews. In another embodiment the report is a live game report, showing information about a game that is in progress along with zero or more interviews. In another embodiment the report is for a non-game event, for example for a tournament, a practice or mid-season update; many other options are also possible.

In the illustrated example, field 640 shows a button which when pressed takes the user to the interview results screen 194 which displays a full set of interview questions and responses.

In another embodiment the post game report and post game report screens 602 contain one or more images or videos (not shown in FIG. 6). The images or videos may have been posted by staff or fans prior, during or after the game using a client device 220, an event input device 210, or an external device 250.

In another embodiment a team chat is automatically created and accessible from the report screen in order for fans to discuss the report (and game).

In another embodiment, the players, staff or fans that are chosen for the interviews are visible from the report screen (or similar such screen), before, during or after the game with an indication of if the interviews for each have been seen, have started or have completed. In another embodiment the time remaining for each interview (before the report is generated) is also displayed. In another embodiment the number of times the report has been viewed is displayed on the reports screen.

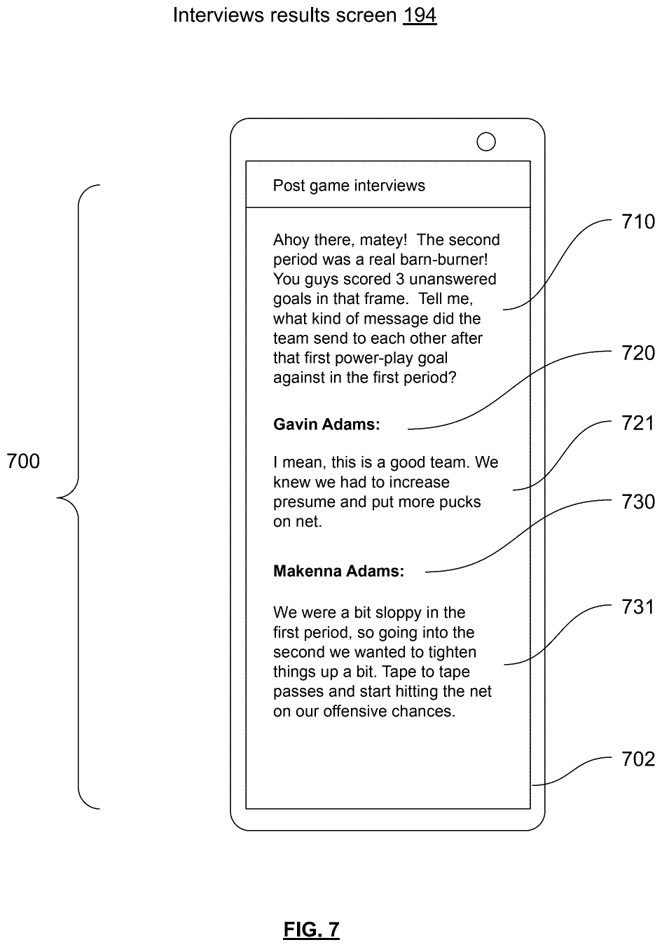

FIG. 7 illustrates an example user interface displaying data entry fields of an interview results screen, in accordance with an example embodiment of the present application. In the illustrated example, a sports application 110 is executing on the electronic device 102.

As illustrated, an example user interface 700 of the sports application 110 is displayed on a screen 702 of the electronic device 102.

The example user interface 700 includes fields 710-731 that are outputted by the sports application 110.

In the illustrated example, field 710 shows a read only text field with an interview question that was asked by the interviewer. In the illustrated example the same question was asked to 2 different players 720 and 730 which each gave separate answers 721 and 731 respectively.

In the illustrated example, only one interview question is displayed in field 710, with multiple responses 721 (response from player 720) and response 731 (response from 730), but in another embodiment multiple questions may be shown with the corresponding answer or answers preceding each question.

FIG. 3 through FIG. 7 have been presented for purposes of illustration and description and are not intended to be exhaustive or limit the embodiments herein to the form disclosed. Many modifications and variations will be apparent to those of ordinary skill in the art, depending on the type of interview or report being generated and the sport being played.

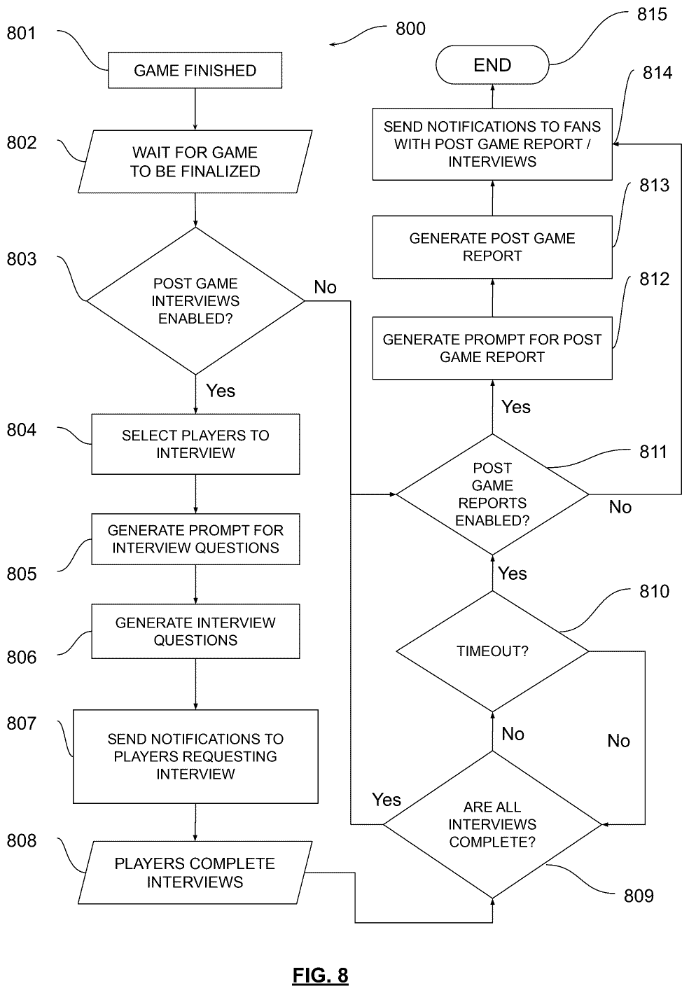

FIG. 8 is a flowchart showing an example process 800 for a system 200, running on zero or more servers 230, zero or more client devices 220 and zero or more event input devices 210, for generating and sending interview questions, gathering interview responses and generating and sending reports, using machine learning models or AI methods, according to an implementation.

The process 800 includes operations that are carried out by one or more processors of the zero or more event input devices 210, zero or more client devices 220, zero or more external devices 250 or the server 230. The process 800 may be implemented, at least in part, through processor executable instructions associated with the sports application 110, the event app 232, the statistics app 234, the user app 236, the interview app 237b, the reports app 238b or a combination thereof.

In some examples, one or more operations may be implemented via processor-executable instructions in other applications or in an operating system stored and executed in memory of the event input device 210, client device 220, the server 230 or an external device 250. The process 800 can be implemented by an electronic device, e.g., the electronic device 102 showing in FIG. 1. The process 800 shown in FIG. 8 can also be implemented using additional, fewer, or different entities. Furthermore, the process 800 shown in FIG. 8 can be implemented using additional, fewer, or different operations which can be performed in the order shown or in a different order.

In some instances, an operation or group of the operations can be iterated or repeated, for example, for a specified number of iterations or until a terminating condition is reached.

The process starts at 801 when a game is finished. A game is considered finished if a user of an event input device 210 manually marks the game as finished. In another embodiment a game is considered finished if the end time of the game (game start plus duration) has elapsed or after a delay from the end time of the game. Other methods for detecting when a game is finished are understood by those of ordinary skill in the art.

At 802 the server 230 waits for the game to be finalized. A finalized game is one that has been reviewed to ensure some level of accuracy such that accurate post game interview questions and a post game report can be generated. As the game context includes events that occurred in the game, the post game interviews and post game report may explicitly or implicitly refer to the goal scorer and therefore the more accurate the game events are, the more accurate the interview questions and report will be.

For example a goal entered during a game may have incorrectly identified a player X as having scored the goal when it was actually player Y who scored the goal, since it is sometimes difficult to see who scored the goal in real time during a game. Waiting for the game to be finalized, provides time for the staff, players or fans to identify issues with the game data, to review the game sheet, to review video recordings of the game or through other means that can identify issues.

At 803 if the post game interviews feature is enabled, flow continues to selecting players to interview at 804, otherwise if the post game interview feature is disabled at 803, flow continues to the post game reports enabled decision at 811. Referring to FIG. 3, the post game interview feature is enabled if the post game interview toggle 312 is enabled on the post game report settings screen 190.

At 804, the server 230 selects which players to interview.

At 804, the number of players to interview may be hard coded, may be selected by a member of the team, maybe randomly determined, may be determined based on the number of players from previous interviews, by other means or a combination thereof.

At 804, selecting which players to interview may be determined based on which players were interviewed in the past such that each player has an equal opportunity to be interviewed over the course of the season. In another embodiment the players selected may be based on the context of the game for important or standout events that occurred during the game (for example a player that scored a goal or a hat trick during this game). In another embodiment the players are selected at random. A combination of the above methods may be used.

At 805, the server 230 generates a prompt for the interview questions using the game context. The prompt is used by the machine learning models or AI methods in order to generate the interview questions. The game context contains events from the game created using event input devices 210, client devices 220, the server 230 and external devices 250. The game context may also contain event records 231 and statistic records 233. The game context may contain other game related information such as the game time, game location, opponent and any other information related to the game. The game context may contain historical or past data such as previous results and statistics against this opponent. The game context may contain cheers and comments from fans that occurred prior or during the game. The game context may include key moments, player statistics, any unique aspects of the game such as pivotal plays, strategic decisions, or standout performances as well as overall performance. Other context information is possible.

The prompt generated at 805 may contain information about the players who will be conducting the interview questions. For example the prompt may contain players names, the gender of the players, the age of the players, the players positions, game or season event or statistics related to the players, other player related data is possible.

In another embodiment, multiple different prompts are generated. For example each prompt may contain a request for interview questions with a different persona.

The prompt may contain a request to generate a certain number of interview questions, interview questions for specific players, interview questions that are generic, interview questions based on the context of the game, other methods or a combination thereof. The prompt may also contain a request to use a specific persona for the interviewer which is hard coded, randomly selected from a list of preselected personas, specified by the user in the post game report settings screen 190 in field 314, or a combination thereof.

The prompt may be pre configured with a placeholder for input parameters that are created at 805 and inserted into the prompt. For example a pre configured prompt may be, “You are a sports reporter, writing a post-game article for a {{sport}}.” and the input parameter may be “sport=hockey team”. When the pre configured prompt and input parameters are combined, the final prompt is “You are a sports reporter, writing a post-game article for a hockey team.”

The process continues at 806 when the server 230 generates a prompt for the interview questions using the game context and the prompt created at 805. Based on this analysis, the system generates a set of interview questions. These questions are designed to elicit insights into the players', coaches'or fans'perspectives on the game's events, their strategies, and their reflections on both successes and areas for improvement. In another embodiment, the generated questions are reviewed for coherence and relevance, ensuring they are well-suited to the context of the game and aligned with the interview's goals.

To generate interview questions following a sports game, various machine learning models and frameworks can be utilized. For instance, large language models like OpenAI's GPT-3 or GPT-4 can be employed to create context-aware, nuanced questions. These models excel at understanding complex language patterns and generating human-like responses, making them suitable for crafting insightful and relevant interview questions based on the game's specific details.

Alternatively, Google's Gemini, known for its capabilities in fine-tuning on specific domains, can be adapted to sports contexts, providing tailored question sets that align with the intricacies of the game. Another approach involves using transformer-based models such as BERT or T5, which can be fine-tuned on sports-related datasets to generate specific and contextually appropriate questions.

In addition to these, bespoke models trained on historical sports interviews and post-game commentary can be developed to generate questions that are not only relevant but also resonate with the typical discourse found in sports journalism. These models can include decision trees, ensemble methods like Random Forests, or even neural networks specialized in natural language processing tasks. By leveraging these advanced models, the system can ensure the generated questions are insightful, targeted, and enhance the overall quality of post-game interviews.

At 807 a push notification is sent by the server 230 to zero or more client devices 220 or zero or more event input devices 210, to alert the interviewees that an interview is available. In another embodiment an email, text message, social message or combination thereof is sent by the server 230 to notify the interviewee that an interview has been requested. In another embodiment the notification for an interviewee that is a player is sent to one or more of the parents, guardians or staff members of the player to complete on their behalf or in collaboration with the player. In another embodiment no notifications are sent and the interviewees manually check for the interview on the client device 220 or event input device 210.

At 808 players complete their interviews on their client device 220 or event input devices 210 after receiving a notification that was sent at 807 using the post game interview screen (text/audio) 191 or using the post game interview screen (video) 192. In another embodiment the user opens the post game interview screen 191, 192 without receiving or opening the notification. The interview is complete when the user presses the finish button 450 or 550 and the results are transmitted to and stored on the server 230.

In another embodiment, players respond to a text message, email message, social message or other messaging protocols or methods, that contains the interview question with a reply containing the interview response instead of using the post game interview screens 191 or 192. Responding to the message causes an interview response to be stored by the server 230 in the same manner as if the user had pressed the finished button 450, 550 but the channel in which the notifications and responses are transmitted to and from the server may be different. For example if an email message is sent at 807 to the player, the player may receive the email message at their personal computer or mobile phone using standard email protocols and applications, the user responds to the email message with the interview response which is sent using standard email protocols back to an email server which relays the response back to the server 230 for processing and storage.

In another embodiment, fans can rate or “thumbs up/down” zero or more interview questions, generated or distributed, to express the quality they see in the questions. In another embodiment, the interview questions and ratings may be used as training data for machine learning models or AI to improve future interview questions.

At 809, the server 230 determines if all of the interviews are complete or not. The interviews are complete if a valid interview response has been received for each interview question generated at 806. If all of the interviews are complete, the process moves to 811 to determine if post game reports are enabled. If not all of the interviews are complete, the process moves to 810 to determine if a timeout condition exists.

At 810, the server 230 determines if a timeout has expired or elapsed. The timeout may start when the notifications are sent to players requesting interviews at 807 or at another suitable time apparent to those of ordinary skill in the art. For example at 810 the server 230 may determine if 1 hour has elapsed since notifications have been sent to players at 807, giving players 1 hour total to complete the interviews before proceeding.

The combination of the interview complete check at 809 and timeout check at 810 are used together to determine if the process 800 should move from the interview process 804-810 to the report process 811-814. In another embodiment, 809 can be omitted and flow continues directly from 808 to 810 so that only the timeout condition is used to determine when the interview process is complete. In another embodiment, 810 can be omitted and flow only continues from 809 to 811 once all the interviews have been received. A combination of these methods or other methods is possible in order to determine when the interview process 804-810 should be considered completed.

At 811, if the post game reports feature is enabled, flow continues to generate prompt for the post game report at 812 and if the post game report feature is disabled at 811, flow continues to the end at 814 where notifications may be sent for interviews and post game reports. Referring to FIG. 3, the post game report feature is enabled if the post game report toggle 311 is enabled on the post game report settings screen 190. In another embodiment, the decision at 811 may be removed and flow continues to 812 to automatically generate a post game report.

At 812, the server 230 generates a prompt for the post game report using the game context. The prompt is used by the machine learning model in order to generate the post game report. The game context contains events from the game created using event input devices 210, client devices 220, server 230 and external devices 250. The game context may also contain event records 231, statistic records 233. The game context may contain other game related information such as the game time, game location, opponent and any other information related to the game. The game context may contain historical or past data such as previous results and statistics against this opponent. The game context may contain cheers and comments from fans that occurred prior or during the game. Other context information is possible.

At 812, the prompt for the post game report may contain interview questions generated at step 806 and interview responses completed at 808 and may have been stored as interview records 237a on the server 230.

In another embodiment the prompt may contain a request to generate multiple post game reports, whereby each fan receives one or more of the generated reports. In another embodiment, the coach, staff or fan chooses which report will be used from the one or more reports generated. In another embodiment each fan receives their own personalized report, possibly generated using a persona they individually specified. Other options for selecting which fans will receive which reports are possible and understood to those of ordinary skill in the art.

The process continues at 813 when the server 230 generates the post-game reports using the prompt created at step 812, which contains the context of the sports game and interview questions and responses. Based on this analysis, the system generates a comprehensive post-game report. This report is designed to provide insights into the game's events, strategies employed by the teams, and reflections on both successes and areas for improvement. In another embodiment, the generated report is reviewed for coherence and relevance, ensuring it is well-suited to the context of the game and aligned with the goals of providing an accurate and detailed summary of the game.

To generate reports following a sports game, various machine learning models and frameworks can be utilized. For instance, large language models like OpenAI's GPT-3 or GPT-4 can be employed to create context-aware, nuanced reports. These models excel at understanding complex language patterns and generating human-like responses, making them suitable for crafting insightful and relevant reports based on the game's specific details.

Alternatively, Google's Gemini, known for its capabilities in fine-tuning on specific domains, can be adapted to sports contexts, providing tailored report sets that align with the intricacies of the game. Another approach involves using transformer-based models such as BERT or T5, which can be fine-tuned on sports-related datasets to generate specific and contextually appropriate reports.

In addition to these, bespoke models trained on historical sports reports and post-game commentary can be developed to generate reports that are not only relevant but also resonate with the typical discourse found in sports journalism. These models can include decision trees, ensemble methods like Random Forests, or even neural networks specialized in natural language processing tasks. By leveraging these advanced models, the system can ensure the generated reports are insightful, targeted, and enhance the overall quality of post-game reports.

At 814, notifications are sent to fans indicating that interviews and post game reports are available. If post game interviews are enabled and were generated, then a push notification indicating interviews are available is sent to fans by the server 230 and a notification is displayed on the client devices 220. If post game reports are enabled and were generated, then a push notification indicating post game reports are available are sent to fans by the server 230 and a notification is displayed on the client devices 220. In another embodiment, if post game interviews and reports were both enabled and generated then a single combined notification is sent to fans by the server 230 and a notification is displayed on the client devices 220.

In another embodiment an email, text message, social message or combination thereof is sent by the server 230 to the fans containing the post game interviews or post game reports. In another embodiment a social media “post” is automatically created and available for posting by the team and is optionally automatically posted to zero or more social media sites.

In one embodiment, all fans on the team are sent a notification and in another embodiment a subset of fans on the team are sent a notification indicating interviews or post game reports are available.

In another embodiment, fans can rate or “thumbs up/down” zero or more reports, generated or distributed, to express the quality they see in the report. Ratings may be shown to other fans when viewing the reports. In another embodiment, ratings may be used to determine which reports are visible to fans that open the reports later, making the higher rated reports more visible than the lower rated reports.

In another embodiment, the post game reports and ratings may be used as training data for machine learning models or AI to improve future reports.

At 815 the process 800 ends.

Process 800 describes generating post game interviews and reports at the server 230 and then distributing them to the client devices 220 and event input devices 210 as an example implementation but other designs are possible. For example in another embodiment the client devices 220 or event input devices 210 may generate the interview questions and reports locally on the electronic device 102. In such a model, or in other embodiments each user may get a custom and uniquely generated post game report possibly also allowing each user to specify their own report persona.

In another embodiment each fan may individually enable and disable post game reports so that post game reports are only generated and distributed to the fans that have the feature enabled. In another embodiment post game reports are a premium feature requiring the user to pay a fee in order to receive post game reports.

### General Considerations

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can be implemented in multiple embodiments, separately or in suitable sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementation described above should not be understood as requiring such separation in all implementations, and it should be understood that the described program components and system can generally be integrated together in a single software product or packaged into multiple software products.

Also, techniques, systems, subsystems, and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

While the above detailed description has shown, described, and pointed out the fundamental novel features of the disclosure, as applied to various implementations, it will be understood that various omissions, substitutions, and changes in the form and details of the system illustrated may be made by those skilled in the art, without departing from the intent of the disclosure. In addition, the order of method steps are not implied by the order in which they appear in the claims.

In the present disclosure a variety of descriptive and intuitive names and labels have been used for the user interface elements such as buttons. These names and labels are not intended to be limiting and other descriptive and intuitive names and labels could be used.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer usable instructions may also be in various forms, including compiled and non-compiled code.

Various embodiments have been described herein by way of example only. Various modifications and variations may be made to these example embodiments without departing from the spirit and scope of any particular invention, which is limited only by the appended claims. Also, in the various user interfaces illustrated in the drawings, it will be understood that the illustrated user interface text and controls are provided as examples only and are not meant to be limiting. Other suitable user interface elements may be possible.

What is claimed is:

1. A method for conducting digital interviews and generating reports for sporting events, the method comprising:
receiving context data related to a sporting event from one or more data sources;
generating, by a computing system, a game context based on the received context data; selecting one or more interview subjects based on the game context;
generating interview questions based on the game context and a selected persona;
sending the interview questions to one or more client devices associated with the interview subjects; receiving interview responses from the client devices;
generating a game-related report using the interview responses and the game context; and sending the game-related report to one or more client devices for display.

2. The method of claim 1, wherein the selected persona is specified by a user from a predefined set of personas stored in the system and is used to influence the tone, vocabulary, or structure of at least one of the interview questions or the game-related report.

3. The method of claim 1, wherein the interview questions are generated using one or more of: a machine learning model, a rule-based engine, an algorithmic logic system, a predefined template, or manually authored content.

4. The method of claim 1, wherein the interview questions are generated by a machine learning model comprising a transformer-based language model trained on sports-related data, and are optionally presented via an interactive conversational user interface configured for real-time adaptive question sequencing that dynamically generates follow-up questions based on prior responses, game context, and a selected persona, thereby simulating a live, back-and-forth interview experience.

5. The method of claim 1, wherein the game context data comprises one or more of: goals, penalties, faceoffs, shots, hits, blocks, takeaways, giveaways, player statistics, time on ice, player attendance or absence, fan comments or cheers, sponsor information, player recognition data, opponent team information, historical game results, upcoming schedule data, biometric sensor data, player, staff, or fan insights, or game metadata including game time, location, or team names.

6. The method of claim 1, wherein selecting the one or more interview subjects is based on game performance, predefined rules, historical participation, random selection, or manual selection.

7. The method of claim 1, wherein the interview responses are received in at least one of: text, audio, video format, or a combination thereof.

8. The method of claim 1, wherein the game-related report includes one or more of the interview questions and corresponding responses, wherein the questions and/or responses may be full, partial, edited, summarized, generated by artificial intelligence, or a combination thereof.

9. The method of claim 1, further comprising enabling fans to rate one or more interviews or game-related reports, wherein the ratings indicate perceived quality, are used to influence the visibility or ranking of the interviews or reports presented to fans, and are utilized as training data to improve machine learning models for generating future interviews or reports.

10. The method of claim 1, wherein the timing of the interview and report generation is configurable as pre-game, in-game, post-game, or a combination thereof.

11. A system for conducting digital interviews and generating reports for sporting events, comprising:
one or more data sources configured to provide game context data related to a sporting event;
a computing system comprising:
a processor and memory;
an interview module configured to:
generate interview questions using a machine learning model based on a game context and a selected persona;
send the interview questions to one or more client devices associated with interview subjects; and
receive interview responses from the client devices;
a report module configured to: generate a game-related report using the interview responses and the game context; and send the game-related report to one or more client devices for display; and
wherein the game context is generated based on the game context data received from the one or more data sources.

12. The system of claim 11, wherein the computing system is further configured to wait for the sporting event to be finalized before generating interview questions.

13. The system of claim 11, wherein the computing system stores historical player interview records to avoid repetition of interview subjects.

14. The system of claim 11, wherein the selected persona affects the structure or language of both the interview questions and the report.

15. The system of claim 11, wherein the game-related report is generated only after interview responses have been received or a timeout period has elapsed.

16. The system of claim 11, wherein the interview module validates responses to exclude profanity or incomplete answers.

17. The system of claim 11, wherein the game-related report is distributed and/or a notification of its availability is sent via push notification, email, or social media post.

18. The system of claim 11, wherein the data sources include at least one of: a scoreboard, a wearable player sensor, or a manual input device.

19. The system of claim 11, wherein the computing system generates multiple personalized versions of the report for different recipients.

20. The system of claim 11, wherein the selected persona is specified by a user.
